(19) United States
(12) Patent Application Publication
(10) Pub. No.: US 2024/0378629 A1
(43) Pub. Date: Nov. 14, 2024

(54) APPARATUS, METHOD AND COMPUTER READABLE STORAGE MEDIUM FOR ANALYZING REFUEL PATTERN

(71) Applicants: HYUNDAI MOTOR COMPANY, Seoul (KR); KIA CORPORATION, Seoul (KR)

(72) Inventors: Young Gul Cho, Seoul (KR); Seung Eun Kim, Seoul (KR); Ji Eun Lee, Seongnam-si (KR); Dong Woo Lee, Suwon-si (KR); Ji Hyun Lee, Seongnam-si (KR); Tae Young Heo, Yongin-si (KR); Ja Ho Koo, Seoul (KR)

(73) Assignees: HYUNDAI MOTOR COMPANY, Seoul (KR); KIA CORPORATION, Seoul (KR)

(21) Appl. No.: 18/490,528

(22) Filed: Oct. 19, 2023

(30) Foreign Application Priority Data
May 10, 2023 (KR) 10-2023-0060262

(51) Int. Cl. G06Q 30/0204; G07C 5/02

(52) U.S. Cl. CPC G06Q 30/0205; G07C 5/02

(57) ABSTRACT

An apparatus for analyzing a refueling pattern includes a processor and a storage medium having stored thereon at least one program configured to be executable by the processor. The at least one program includes instructions for executing operations. The operations may include receiving a starting state of an engine, global positioning system (GPS) information, and a remaining amount of fuel transmitted in real time. The operations may also include analyzing a customer refueling pattern based on the starting state of the engine, the GPS information and the remaining amount of fuel.

### CROSS-REFERENCE TO RELATED APPLICATION(S)

The present application claims the benefit of and priority to Korean Patent Application No. 10-2023-0060262 filed on May 10, 2023, the entire contents of which is incorporated herein by reference.

### TECHNICAL FIELD

The present disclosure relates to an apparatus, a method, and a computer readable storage medium for analyzing a refueling pattern.

### BACKGROUND

Refueling plays a large role in maintenance and management in a vehicle. Accordingly, it is very important for a customer to analyze the customer's own refueling pattern for efficient refueling management. A car account book application may be used to analyze a normal refueling pattern. For example, the customer may directly input data, such as refueling details, into the car account book application and/or may analyze the refueling pattern in conjunction with text messages containing card payment details. However, when paying in cash, data input omission is likely to occur, and when multiple refueling cards are used, it is inconvenient to register all refueling cards.

In addition, if gas stations and card companies that issue refueling discount cards do not accurately analyze a customer refueling pattern, there is a limit to the development and marketing of customized products and services.

### SUMMARY

Embodiments of the present disclosure provide an apparatus, a method, and a computer readable storage medium for analyzing a refueling pattern, which can collect accurate customer data by a vehicle unit, reduce inconvenience of missing data input or registering all refueling cards, and at the same time, can be used for developing and marketing customized products and services by card companies, oil companies, or the like.

According to an embodiment of the present disclosure, an apparatus for analyzing a refueling pattern is provided. The apparatus includes a processor and a storage medium recording at least one program configured to be executable by the processor. The at least one program includes instructions for executing operations. The operations include receiving a starting state of an engine, global positioning system (GPS) information, and a remaining amount of fuel transmitted in real time. The operations also include analyzing a customer refueling pattern based on the starting state of the engine, the GPS information, and the remaining amount of fuel.

According to another embodiment of the present disclosure, a method for analyzing a refueling pattern is provided. The method may be performed in a computing device having a processor and a storage medium recording at least one program configured to be executable by the processor. The method includes receiving a starting state of an engine, global positioning system (GPS) information, and a remaining amount of fuel transmitted in real time. The method also includes analyzing a customer refueling pattern based on the starting state of the engine, the GPS information, and the remaining amount of fuel.

According to yet another embodiment of the present disclosure, a non-transitory computer-readable storage medium storing instructions that, when executed by a processor, cause the processor to perform operations. The operations include receiving a starting state of an engine, global positioning system (GPS) information, and a remaining amount of fuel transmitted in real time. The operations also include analyzing a customer refueling pattern based on the starting state of the engine, the GPS information, and the remaining amount of fuel.

### BRIEF DESCRIPTION OF DRAWINGS

The above and other aspects, features, and advantages of the present disclosure should be more clearly understood from the following detailed description taken in conjunction with the accompanying drawings, in which:

FIG. 1 is a diagram illustrating a system including an apparatus for analyzing a refueling pattern, according to an embodiment of the present disclosure;

FIG. 2 is a diagram illustrating a starting state of an engine and a remaining amount of fuel for analyzing a refueling pattern, according to an embodiment of the present disclosure;

FIG. 3 is a diagram illustrating a result of analyzing a refueling pattern, according to an embodiment of the present disclosure;

FIG. 4 is a diagram illustrating a marketing screen provided by a third party based on a result of analyzing a refueling pattern, according to an embodiment of the present disclosure;

FIG. 5 is a flowchart illustrating a method of analyzing a refueling pattern, according to an embodiment of the present disclosure; and

FIG. 6 is a block diagram of a computing device capable of fully or partially implementing a vehicle terminal and an apparatus for analyzing a refueling pattern, according to an embodiment of the present disclosure.

### DETAILED DESCRIPTION

Hereinafter, embodiments of the present disclosure are described with reference to the accompanying drawings. The detailed descriptions that follow are provided to facilitate a comprehensive understanding of the methods, devices and/or systems described herein. However, this is merely an example, and the present disclosure is not limited thereto.

In describing the embodiments of the present disclosure, if it is determined that the detailed description of the known technology related to the present disclosure may unnecessarily obscure the subject matter of the present disclosure, the detailed description thereof is omitted. In addition, terms used in the detailed description are terms defined in consideration of functions in the present disclosure, which may vary according to the intention or custom of a user or operator. Therefore, the definitions should be made based on the contents throughout this specification. The terminology used in the detailed description is only for describing the embodiments of the present disclosure and should in no way be limiting. Unless expressly used otherwise, singular forms of expression include plural forms.

In the following description, expressions such as “comprising” or “comprising” are intended to indicate any characteristic, number, step, operation, element, portion or combination thereof, one or more other than those described, and it should not be construed to exclude the existence or possibility of any other feature, number, step, operation, element, part or a combination thereof.

When a component, device, element, or the like of the present disclosure is described as having a purpose or performing an operation, function, or the like, the component, device, or element should be considered herein as being “configured to” meet that purpose or perform that operation or function.

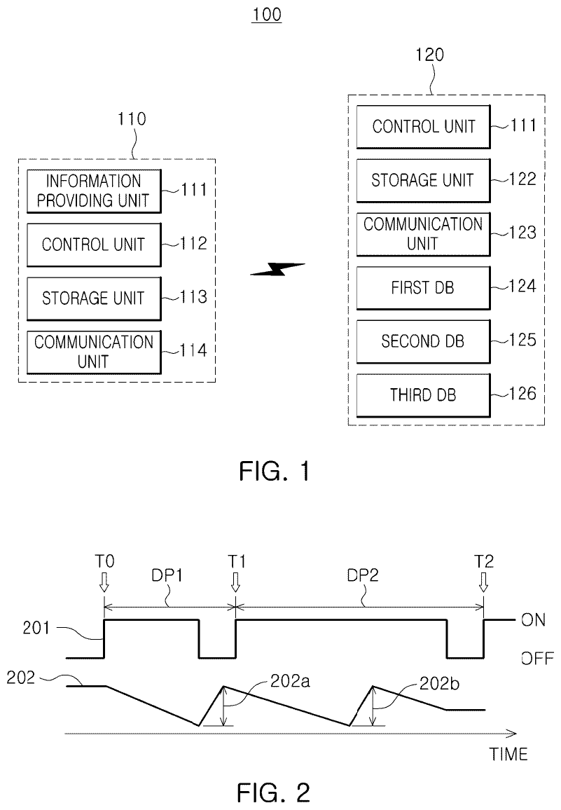

FIG. 1 is a diagram illustrating a system 100 including a vehicle terminal 110 and an apparatus for analyzing a refueling pattern 120, according to an embodiment of the present disclosure.

The vehicle terminal 110 includes an information providing unit 111, a control unit 112, a storage unit 113, and a communication unit 114. The vehicle terminal 110 may be mounted on a vehicle.

The information providing unit 111 may provide data for refueling pattern analysis to the control unit 112. The data for refueling pattern analysis may include a starting state of an engine (ON or OFF), a remaining amount of fuel, and global positioning system (GPS) information of a vehicle including date and time information.

The control unit 112 may control the communication unit 114 to transmit the starting state of the engine, GPS information, and the remaining amount of fuel to the apparatus for analyzing a refueling pattern 120 in real time. Real time may be, for example, in units of seconds.

According to an embodiment of the present disclosure, the information providing unit 111 may further provide an open state of a fuel cap, and the provided open state of the fuel cap may be transmitted to the apparatus for analyzing a refueling pattern 120 in real time.

The storage unit 113 may be a module for storing various programs for implementing functions performed by the control unit 112 described herein.

The communication unit 114 may transmit and receive various types of data described herein with the apparatus for analyzing a refueling pattern 120 under the control of the control unit 112. Data transmitted and received between the apparatus for analyzing a refueling pattern 120 and the vehicle terminal 110, including the above-described starting state of the engine, GPS information, remaining amount of fuel, and the like, may also be referred to as connected car data.

The apparatus for analyzing a refueling pattern 120 may include a control unit 121, a storage unit 122, a communication unit 123, a first database 124, a second database 125, and a third database 126.

The first database 124 may store tag criteria set based on each of one or more of the number of times of refueling, refueling amount, refueling cost, gas station information, and refueling time periods, or a combination thereof. The first database 124 may also store a tag assigned to the tag criteria. Table 1 below illustrates tag criteria and tags stored in the first database 124, according to embodiments.

TABLE 1

| TAG | | | TAG |
|---|---|---|---|
| CLASSIFICATION | TAG (NO.) | TAG CRITERIA | RATIO |
| THE NUMBER OF | THE NUMBER OF | THE NUMBER OF TIMES OF REFUELING | **% |
| TIMES OF | REFUELING IS | WITHIN THE PERIOD IS LESS THAN 5 TIMES | |
| REFUELING | LOW (TAG 1) | | |
| | THE NUMBER OF | THE NUMBER OF TIMES OF REFUELING | **% |
| | TIMES OF | WITHIN THE PERIOD IS 5 TIMES OR MORE, | |
| | REFUELING IS | ONCE A WEEK OR MORE | |
| | HIGH (TAG 2) | | |
| REFUELING | REFUELING | A RATIO OF REFUELING UP TO 90% OR MORE | **% |
| AMOUNT | AMOUNT IS HIGH | OF THE NUMBER OF TIMES OF REFUELING | |
| | (TAG 3) | WITHIN THE PERIOD IS 80% OR MORE | |
| | REFUELING | A RATIO OF REFUELING UP TO 90% OR MORE | **% |
| | AMOUNT IS LOW | OF THE NUMBER OF TIMES OF REFUELING | |
| | (TAG 4) | WITHIN THE PERIOD IS LESS THAN 50% | |
| REFUELING COST | REFUELING COST | A RATIO OF REFUELING OF 60,000 WON OR | **% |
| | IS HIGH (TAG 5) | MORE OF THE NUMBER OF TIMES OF | |
| | | REFUELING WITHIN THE PERIOD IS 70% OR | |
| | | MORE | |
| | REFUELING COST | A RATIO OF REFUELING OF 20,000 WON OR | **% |
| | IS LOW (TAG 6) | MORE OF THE NUMBER OF TIMES OF | |
| | | REFUELING WITHIN THE PERIOD IS LESS | |
| | | THAN 70% | |
| GAS STATION | SELF REFUELING | A RATIO OF REFUELING OF VISITING TO | **% |
| INFORMATION | (TAG 7) | SELF-SERVICE GAS STATION OF THE NUMBER | |
| | | OF TIMES OF REFUELING WITHIN THE | |
| | | PERIOD IS 75% OR MORE | |
| | REFUELING | A RATIO OF REFUELING OF VISITING TO | **% |
| | PREMIUM FUEL | GAS STATION WITH PREMIUM FUEL OF THE | |
| | (TAG 8) | NUMBER OF TIMES OF REFUELING WITHIN | |
| | | THE PERIOD IS 90% OR MORE | |
| | REGULAR | A RATIO OF VISITING TO GAS STATION WITH | **% |
| | CUSTOMER (TAG | THE HIGHEST FREQUENCY OF THE NUMBER OF | |
| | 9) | TIMES OF REFUELING WITHIN THE PERIOD | |
| | | IS 80% OR MORE | |
| REFUELING TIME | DAWN (TAG 10) | A RATIO OF REFUELING DURING MORNING | **% |
| PERIOD | | TIME PERIODS (1:00-6:00) OF THE NUMBER | |
| | | OF TIMES OF REFUELING WITHIN THE | |
| | | PERIOD IS 70% OR MORE | |
| | WAY TO WORK | A RATIO OF REFUELING DURING WAY-TO- | **% |
| | (TAG 11) | WORK TIME PERIODS (6:00-11:00) OF THE | |
| | | NUMBER OF TIMES OF REFUELING WITHIN | |
| | | THE PERIOD IS 70% OR MORE | |
| | AFTERNOON (TAG | A RATIO OF REFUELING DURING AFTERNOON | **% |
| | 12) | TIME PERIODS (11:00-16:00) OF THE | |
| | | NUMBER OF TIMES OF REFUELING WITHIN | |
| | | THE PERIOD IS 70% OR MORE | |
| | LEAVE WORK | A RATIO OF REFUELING DURING LEAVE-WORK | **% |
| | (TAG 13) | TIME PERIODS (16:00-21:00) OF THE | |
| | | NUMBER OF TIMES OF REFUELING WITHIN | |
| | | THE PERIOD IS 70% OR MORE | |
| | LATE AT NIGHT | A RATIO OF REFUELING DURING LATE AT | **% |
| | (TAG 14) | NIGHT TIME PERIODS (21:00-09:00) OF | |
| | | THE NUMBER OF TIMES OF REFUELING | |
| | | WITHIN THE PERIOD IS 70% OR MORE | |
| PRICE | VERY SENSITIVE | A RATIO OF VISITING TO GAS STATION | **% |
| SENSITIVITY | (TAG 15) | CHEAPER THAN 20 WON COMPARED TO | |
| | | AVERAGE VALUE OF REFUELING UNIT PRICE | |
| | | OF THE NUMBER OF TIMES OF REFUELING | |
| | | WITHIN THE PERIOD IS 90% OR MORE | |
| | SENSITIVE (TAG | A RATIO OF VISITING TO GAS STATION | |
| | 16) | CHEAPER THAN 20 WON COMPARED TO | **% |
| | | AVERAGE VALUE OF REFUELING UNIT PRICE | |
| | | OF THE NUMBER OF TIMES OF REFUELING | |
| | | WITHIN THE PERIOD IS 70% OR MORE | |
| | INSENSITIVE | A RATIO OF VISITING TO GAS STATION | **% |
| | (TAG 17) | CHEAPER THAN 10 WON COMPARED TO | |
| | | AVERAGE VALUE OF REFUELING UNIT PRICE | |
| | | OF THE NUMBER OF TIMES OF REFUELING | |
| | | WITHIN THE PERIOD IS 50% OR MORE | |
| REMAINING | INSENSITIVE | A RATIO OF REFUELING STARTED WITH | **% |
| AMOUNT | (TAG 18) | REMAINING AMOUNT OF 10 LITERS OR LESS | |
| SENSITIVITY | | OF THE NUMBER OF TIMES OF REFUELING | |
| | | WITHIN THE PERIOD IS 80% OR MORE | |
| | SENSITIVE (TAG | A RATIO OF REFUELING STARTED WITH | **% |
| | 19) | REMAINING AMOUNT OF 10 LITERS OR LESS | |
| | | OF THE NUMBER OF TIMES OF REFUELING | |
| | | WITHIN THE PERIOD IS 10% OR LESS | |

Referring to Table 1, when, for example, the number of times of refueling within a period (e.g., 6 months) is less than 5 times, a tag stating that the number of times of refueling is low (tag 1) may be assigned. As another example, when a ratio of refueling up to 90% or more of the number of times of refueling within the period is 80% or more, a tag stating that a refueling amount is high (tag 3) may be assigned. In other words, if among the refueling instances within a certain time period, the proportion of refueling with quantities equal to or exceeding 90% is 80% or more, tag 3 indicating high refueling amount may be assigned.

Table 1 is provided as an illustrative example to aid in an understanding of the present disclosure, and the present disclosure is not limited to Table 1. Accordingly, various other tag criteria and tags may be applied. In an embodiment, Table 1 is derived for a predetermined number of customers (e.g., 3 million), and a tag ratio is a ratio of the number of customers satisfying the corresponding tag criteria to the total number of customers.

The second database 125 may store a plurality of segments composed of combinations of two or more tags. Table 2 below illustrates segments stored in the second database 125, according to an embodiment.

TABLE 2

| SEGMENT NAME | DESCRIPTION (TAG NO.) |
|---|---|
| COMMUTE TYPE | THE NUMBER OF TIMES OF REFUELING IS HIGH DURING |
| | COMMUTING TIMES (TAGS 2, 11, 13) |
| SELF-REFUELING | A RATIO OF VISITING TO SELF-SERVICE GAS STATION |
| PREFERREED TYPE | IS 75% OR MORE (TAGS 2, 7) |
| REGULAR CUSTOMER TYPE | A RATIO OF MOST FREQUENTLY VISITING TO GAS |
| | STATION IS 80% OR MORE (TAGS 2, 9) |
| OWL TYPE (THE TYPE, | REFUELING AT DAWN AND LATE AT NIGHT HOURS (TAGS |
| MAINLY ACTIVE AT | 2, 10, 14) |
| NIGHT) | |
| REFUELING AVOIDANCE | WHEN REFUELING AMOUNT ONCE IS LOW DUE TO BEING |
| TYPE | INSENSITIVE TO THE REMAINING OIL AMOUNT (TAGS |
| | 2, 4, 18) |
| ECONOMY TYPE | WHEN PREFERRING SELF-REFUELING DUE TO BEING |
| | VERY SENSITIVE TO OIL PRICE (TAGS 2, 7, 14) |
| COST INSENSITIVE TYPE | INSENSITIVE TO GAS STATION UNIT PRICE |

Referring to Table 2, in the case of, for example, a segment named a commute type, as illustrated in Table 1, the segment may be a combination of a tag stating that the number of times of refueling is high (tag 2), a tag named a ratio of refueling during way to work time periods of the number of times of refueling (tag 11), and a tag named a ratio of refueling during leave work of the number of times of refueling (tag 13). As another example, in the case of a segment named a self-refueling preferred type, as shown in Table 1, the segment may be a combination that the number of times of refueling is high (tag 2) and self-refueling (tag 7).

Table 2 is provided as an illustrative example to aid in an understanding of the present disclosure, and the present disclosure is not limited to Table 2. Accordingly, there may be other combinations of various tags.

The third database 126 may store customer information (e.g., customer ID, vehicle ID, home GPS information, and company GPS information), gas station information (e.g., gas station name including brand, GPS information, whether self-car wash is available, whether premium fuel is available, real-time refueling unit price for each gas station), and real-time fuel unit price. In addition, the third database 126 may sequentially store the starting state of the engine, GPS information, and the remaining amount of fuel received in real time from the vehicle terminal 110 according to time.

The control unit 121 may control the communication unit 123 to receive a starting state of the engine, GPS information, and remaining amount of fuel transmitted from the vehicle terminal 110 in real time, and may analyze a customer refueling pattern based on the starting state of the engine, GPS information, and the remaining amount of fuel. The customer refueling pattern may mean a customer refueling tendency including at least one of a refueling amount, gas station information, a refueling time period, a refueling cost, and the number of times of refueling, obtained based on a starting state of an engine, GPS information, and a remaining amount of fuel.

In order to analyze the customer refueling pattern, the control unit 121 may determine whether an amount of change in a remaining amount of fuel within a unit driving section is equal to or greater than a predetermined change amount. The unit driving section may be a section between a current point in time at which the starting state of the engine is in an ON state and a point in time immediately therebefore when the starting state of the engine is in an ON state. In addition, the predetermined change amount corresponds to a refueling amount, and may be, for example, 5 liters. However, it should be apparent to those having ordinary skill in the art that this example is provided to aid in an understanding of the present disclosure, and specific values can be modified as desired, in various embodiments.

When it is determined that the amount of change in the remaining amount of fuel is equal to or greater than the predetermined change amount, the control unit 121 may obtain refueling history information within a unit driving section, by referring to the third database 126. The refueling history information may include gas station information, refueling amount, refueling time period, refueling cost, and the number of times of refueling.

The refueling amount may be a change amount of a remaining amount of fuel before and after refueling. As an example, the refueling amount may be directly measured through a sensor. In another example, the refueling amount may be a change in a driving distance (DTE) before and after refueling/driving fuel efficiency, where the driving fuel efficiency may be the sum of the driving distance/the sum of fuel consumption. As described above, the driving fuel efficiency may be calculated in various ways, such as in units of the last 6 months and units of the last 1 month.

The gas station information may be information on gas stations existing within a predetermined radius centered on GPS information of a vehicle at a point in time at which the remaining amount of fuel is changed. The gas station information may include at least one of a name including a brand, whether premium fuel is refueled, and whether self-refueling is possible.

The refueling time period may be a date and time at which the remaining amount of fuel is changed.

The refueling cost may be an amount obtained by multiplying a refueling amount by a real-time refueling unit price of the corresponding gas station at a point in time at which the remaining amount of fuel is changed.

The number of times of refueling may be the number of times of refueling within a unit driving section.

FIG. 2 is a diagram illustrating a starting state of an engine and a remaining amount of fuel for analyzing a refueling pattern according, to an embodiment of the present disclosure. The diagram of FIG. 2 depicts a starting state of an engine (ON or OFF) 201 and a remaining amount of fuel 202 with a change in the remaining amount of fuel 202, 202b.

In an embodiment, the starting state of the engine 201 and the remaining amount of fuel 202 received from the vehicle terminal 110 are stored in the third database 125 in real time along with GPS information of the vehicle in a time sequence.

When the starting state of the engine is ON, when a change amount 202a of the remaining amount 202 is equal to or greater than a predetermined change amount within a unit driving section DP1 from a point in time T1 when the starting state of the engine is ON to a point in time T1 immediately before the starting state of the engine is ON, the control unit 121 may obtain refueling history information within the unit driving section DP1. The refueling history information may include gas station: information, refueling amount, refueling time period, refueling cost, and the number of times of refueling. The unit driving section DP1 may correspond to a case where refueling is performed at a gas station while the engine is turned off, and the engine is turned on after refueling is completed.

Similarly, when a change amount 202b of the remaining amount 202 of fuel is equal to or greater than a predetermined change amount within a unit driving section DP2 from a point in time T2 when the starting state of the engine is ON to a point in time T1 immediately before the starting state of the engine is ON, the control unit 121 may obtain refueling history information within the unit driving section DP2. The refueling history information may include gas station information, refueling amount, refueling time period, refueling cost, and the number of times of refueling. The unit driving section DP2 may correspond to a case of refueling while the engine is turned on at a gas station.

As described above, the analysis of the refueling pattern may be performed whenever the starting state of the engine is ON, but the present disclosure is not limited thereto. For example, the apparatus for analyzing a refueling pattern 120 may receive an opening/closing state of a fuel cap in real time, and in this case, the control unit 121 may analyze the refueling pattern whenever the fuel cap is opened and then closed.

In an embodiment, the control unit 121 may analyze the refueling pattern based on the refueling history information for a predetermined period. The predetermined period may be, for example, 6 months. However, this example is provided merely to aid in an understanding of the present disclosure, and it should be apparent to those having ordinary skill in the art that specific numerical values may be modified and implemented as desired, in various embodiments.

In an embodiment, the control unit 121 may extract a tag assigned to tag criteria satisfying the refueling history information by referring to the first database 124. Accordingly, tags may be extracted from Table 1 stored in the first database 124. For example, when the number of times of refueling within a period (e.g., 6 months) is less than 5 times, a tag (tag 1) stating that the number of times of refueling is low, satisfying the tag criteria, may be extracted. When the number of times of refueling within the period is 5 or more times and is more than once a week, a tag (tag 3) of a large amount of refueling satisfying the tag criteria may be extracted.

The control unit 121 may extract a segment corresponding to a combination of two or more tags by referring to the second database 125. Accordingly, a segment may be extracted from Table 2 stored in the second database 125. For example, when the refueling history information satisfies tag criteria of the number of times of refueling being high (tag 2), being way to work during refueling time period (tag 11), and leaving work (tag 13), a segment that is a combination of tag 2, tag 11, and tag 13 (segment name: commute type) may be extracted. Similarly, if the refueling history information satisfies the tag criteria of the number of times of refueling being high (tag 2), and self-refueling (tag 7), a segment (segment name: self-refueling preferred type) that is a combination of tags 2 and 7 may be extracted.

In various embodiments, as described above, a plurality of segments may be extracted. Accordingly, the analysis result of the refueling pattern extracted based on the refueling history information may be, for example, commute type and self-refueling type.

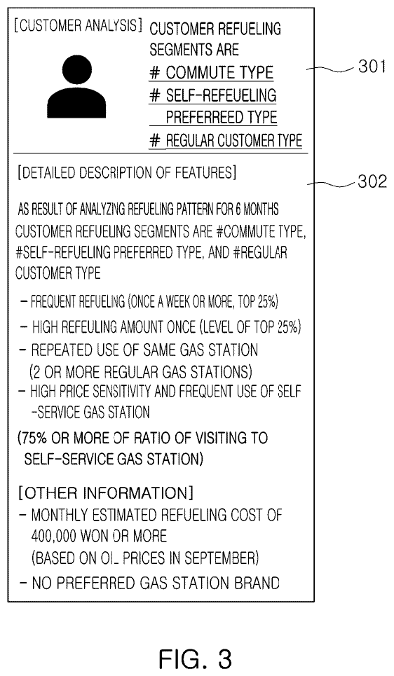

FIG. 3 is a diagram illustrating a result of analyzing a refueling pattern, according to an embodiment of the present disclosure.

As shown in FIG. 3, the analysis result of the customer refueling pattern for 6 months may include i) a main segment 301 including a #commute type, a #self-refueling preferred type, and a #regular customer type and ii) an output section 302 including a detailed feature description. FIG. 3 is merely an example, and it should be noted that the present disclosure is not limited to the specific form shown in FIG. 3.

The analysis result of such a refueling pattern may be provided to card companies, oil companies, or the like, in a form of an open Application Programming Interface (API).

The storage unit 122 may be a module for storing various programs for implementing functions performed by the control unit 121 described above.

The communication unit 123 may transmit and receive various types of data with the vehicle terminal 110 under the control of the control unit 121.

According to an embodiment of the present disclosure, the segment or tag, e.g., as described above, may be provided to a third party, such as card companies, oil companies, or the like, in a form of an open Application Programming Interface (API).

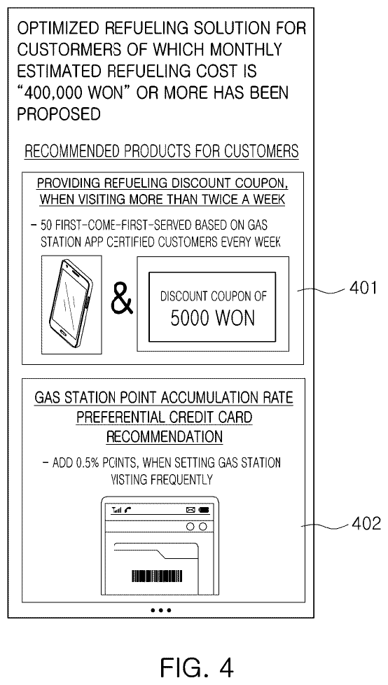

FIG. 4 is a diagram illustrating a marketing screen provided by a third party based on a result of analyzing a refueling pattern, according to an embodiment of the present disclosure.

As shown in FIG. 4, a third party, such as a card company, an oil company, or the like, may use the marketing screen for developing and marketing customized products and services by recommending discount coupons to customers 401 or recommending credit cards 402 for a customer whose refueling cost is 400,000 won or more.

FIG. 4 is a merely an example to aid in an understanding of the present disclosure, and it should be noted that the present disclosure is not limited to the specific form shown in FIG. 4.

As described above, according to an embodiment of the present disclosure, by analyzing the customer refueling pattern based on the starting state of the engine, the global positioning system (GPS) information, and the remaining amount of fuel transmitted in real time from the vehicle terminal, accurate data for each vehicle unit may be collected, and inconvenience of missing data input or registering all refueling cards may be reduced.

In addition, according to an embodiment of the present disclosure, the analysis result of the refueling pattern may be provided in a form of an open Application Programming Interface (API), so that the result may be used for developing and marketing customized products and services by card companies, refineries, or the like.

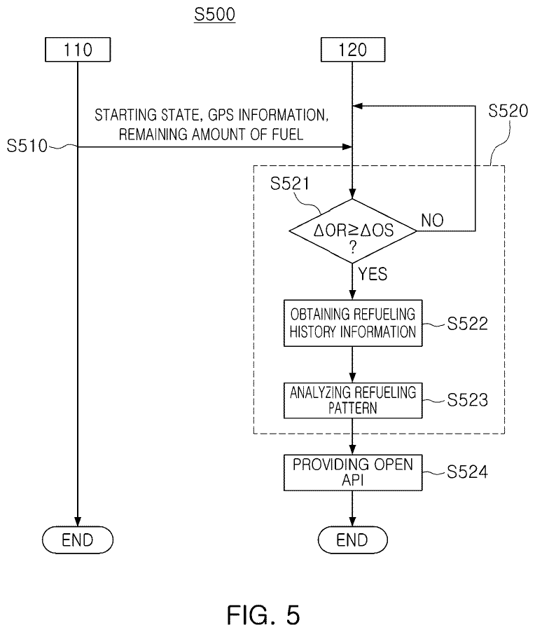

FIG. 5 is a flowchart illustrating a method for analyzing a refueling pattern, according to an embodiment of the present disclosure.

Hereinafter, a method S500 for analyzing a refueling pattern according to an embodiment of the present disclosure is described with reference to FIGS. 1 to 5. However, overlapping descriptions thereof with those of FIGS. 1 to 4 are omitted for simplicity of the disclosure.

Referring to FIGS. 1 to 5, the method S500 for analyzing a refueling pattern according to an embodiment of the present disclosure may be initiated by an operation S510 in which a starting state of an engine, GPS information, and a remaining amount of fuel may be transmitted to an apparatus for analyzing a refueling pattern 120 in real time by a vehicle terminal 110.

In an operation S520, the apparatus for analyzing a refueling pattern 120 may receive the starting state of the engine, the GPS information, and the remaining amount of fuel transmitted in real time from the vehicle terminal 110, and analyze a customer refueling pattern based on the received starting state of the engine, the GPS information, and the remaining amount of fuel.

As described above, the customer refueling pattern may mean a customer refueling tendency including at least one of a refueling amount, gas station information, a refueling time period, a refueling cost, and the number of times of refueling, obtained based on a starting state of an engine, GPS information, and a remaining amount of fuel.

In an operation S521, the apparatus for analyzing a refueling pattern 120 may determine whether a change in the remaining amount of fuel (ΔOR) within a unit driving section is equal to or greater than a predetermined change amount (ΔOS).

The unit driving section may be a section between a current point in time at which the starting state of the engine is ON and a point in time immediately before the starting state of the engine is ON.

As a determination result in the operation S521, when an amount of change in the remaining amount of fuel is equal to or greater than the predetermined change amount, the method S500 may proceed to an operation S522 in which the apparatus for analyzing a refueling pattern 120 may obtain refueling history information within a unit driving section by referring to the third database 126. The refueling history information may include gas station information, refueling amount, refueling time period, refueling cost, and the number of times of refueling.

The refueling amount may be a change amount of a remaining amount of fuel before and after refueling. As an example, the refueling amount may be directly measured through a sensor or may be a change amount of a driving distance (DTE) before and after refueling/driving fuel efficiency, where the driving fuel efficiency may be the sum of the driving distance/the sum of fuel consumption. As described above, the driving fuel efficiency may be calculated in various ways, such as in units of the last 6 months and units of the last 1 month. The gas station information may be information on gas stations existing within a predetermined radius centered on GPS information of a vehicle at a point in time at which the remaining amount of fuel is changed, and may include at least one of a name including a brand, whether premium fuel is refueled, and whether self-refueling is possible. In an embodiment, if there are two or more gas stations existing within a predetermined radius (e.g., 50 meters), the gas station may be a gas station closest to GPS information of the vehicle at a point in time at which the remaining amount of fuel is changed. The refueling time period may be a date and time at which the remaining amount of fuel is changed. The refueling cost may be an amount obtained by multiplying a refueling amount by a real-time refueling unit price of the corresponding gas station at a point in time at which the remaining amount of fuel is changed. As described above, the above-described number of times of refueling may be the number of times of refueling within a unit driving section.

According to an embodiment of the present disclosure, the apparatus for analyzing a refueling pattern 120 may receive an opening/closing state of a fuel cap in real time, and in this case, as described above, a refueling pattern may be analyzed each time the fuel cap is opened and then closed by the apparatus for analyzing a refueling pattern 120.

In an operation S523, the apparatus for analyzing a refueling pattern 120 may analyze a refueling pattern based on refueling history information for a predetermined period.

For example, the apparatus for analyzing a refueling pattern 120 may extract a tag assigned to tag criteria satisfying the refueling history information by referring the first database 124 described above.

The apparatus for analyzing a refueling pattern 120 may extract a segment corresponding to a combination of two or more tags by referring to the above-described second database 125.

In an operation S524, an analysis result of the refueling pattern may be provided to card companies, refineries, or the like, in a form of an open Application Programming Interface (API).

As described above, according to an embodiment of the present disclosure, by analyzing a customer refueling pattern based on the starting state of the engine, the global positioning system (GPS) information, and the remaining amount of fuel, transmitted in real time from a vehicle terminal, accurate data of each vehicle unit may be collected, and inconvenience of missing data input or registering all refueling cards can be reduced.

In addition, according to an embodiment of the present disclosure, an analysis result of the refueling pattern is provided in a form of an open Application Programming Interface (API), so that the result may be used for developing and marketing customized products and services by card companies, oil companies, or the like.

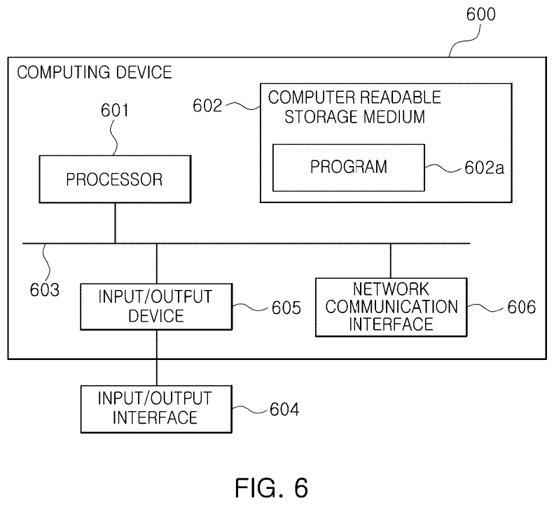

FIG. 6 is a block diagram of a computing device 600 that can wholly or partially implement a vehicle terminal and an apparatus for analyzing a refueling pattern, according to an embodiment of the present disclosure. The computing device 600 may be utilized with the vehicle terminal 110 and the apparatus for analyzing a refueling pattern 120 illustrated in FIG. 1, in an embodiment.

As illustrated in FIG. 6, a computing device 600 includes at least one processor 601, a computer readable storage medium 602, and a communication bus 603.

The processor 601 may allow the computing device 600 to operate according to embodiments of the present disclosure. The processor 601 may execute one or more programs stored in the computer readable storage medium 602. The one or more programs may include one or more computer executable instructions, and when executed by the processor 601, may be configured to cause the computing device 600 to perform operations according to an embodiment of the present disclosure. The processor 601 may implement the control units 112 and 121 illustrated in FIG. 1, for example.

The computer-readable storage medium 602 is configured to store computer-executable instructions or program codes, program data, and/or other suitable form of information. A program 602a stored on the computer readable storage medium 602 includes a set of instructions executable by the processor 601. In an embodiment, the computer readable storage medium 602 may include a memory (volatile memory such as random access memory, non-volatile memory, or a suitable combination thereof), one or more magnetic disk storage devices, optical disk storage devices, flash memory devices, other forms of storage media that can be accessed by computing device 600 and store desired information, or suitable combinations thereof. The computer readable storage medium 602 may implement the storage units 113 and 122 illustrated in FIG. 1, for example.

The communication bus 603 interconnects various other components of computing device 600, including a processor 601 and a computer-readable storage medium 602.

The computing device 600 may also include one or more input/output interfaces 604 and one or more network communication interfaces 606 providing an interface for one or more input/output devices 605. The input/output interface 604 and the network communication interface 606 are connected to a communication bus 603. The network communication interface 606 may implement the communication units 114 and 123 shown in FIG. 1, for example. The input/output device 605 may be connected to other components of the computing device 600 through the input/output interface 604. The input/output devices 605 may include an input device such as a pointing device (such as a mouse, trackpad, or the like), a keyboard, a touch input device (such as a touchpad, touchscreen, or the like), a voice or sound input device, various types of sensor devices, and/or a photographing device, and an output device such as a display device, a printer, a speaker, and/or a network card. The input/output device 605 may be included inside the computing device 600 as a component constituting the computing device 600, or may be connected to the computing device 600 as a separate device, distinct from the computing device 600.

Embodiments of the present disclosure may include a program for performing the methods described in the present specification on a computer, and a computer readable recording medium including the program. The computer readable recording medium may include program instructions, local data files, local data structures, and the like, alone or in a combination thereof. The media may be specially designed and configured for the present disclosure, or may be commonly available in the field of computer software. Examples of computer-readable media include magnetic media such as hard disks, floppy disks and magnetic tapes, optical recording media such as CD-ROMs and DVDs, and hardware devices, specially configured to store and execute program instructions, such as ROM, RAM, flash memory, and the like. Examples of the program may include not only machine language codes generated by a compiler, but also high-level language codes that can be executed by a computer using an interpreter.

As set forth above, according to an embodiment of the present disclosure, by analyzing a customer refueling pattern based on a starting state of an engine, global positioning system (GPS) information, and a remaining amount of fuel, transmitted in real time from a vehicle terminal, accurate data by a vehicle unit may be collected, and inconvenience of missing data input or registering all refueling cards may be reduced.

In addition, according to an embodiment of the present disclosure, a result of analyzing the refueling pattern may be provided in a form of an application programming interface (API), so that card companies, oil refinery companies, or the like, may use the result for developing and marketing customized products and services.

While the example embodiments have been illustrated and described above, it should be apparent to those having ordinary skill in the art that modifications and variations could be made without departing from the scope of the present disclosure as defined by the appended claims.

What is claimed is:

1. An apparatus for analyzing a refueling pattern, the apparatus comprising:
a processor; and
a non-transitory storage medium having stored thereon at least one program configured to be executable by the processor,
wherein the at least one program includes instructions for executing operations of:
receiving a starting state of an engine, global positioning system (GPS) information, and a remaining amount of fuel transmitted in real time, and
analyzing a customer refueling pattern based on the starting state of the engine, the GPS information, and the remaining amount of fuel.

2. The apparatus of claim 1, wherein the refueling pattern comprises a customer refueling tendency including at least one of a refueling amount, gas station information, a refueling time period, a refueling cost, and a number of times of refueling, obtained based on the starting state of the engine, the GPS information, and the remaining amount of the fuel.

3. The apparatus of claim 1, wherein the at least one program further comprises instructions for executing operations of:
determining whether an amount of change in the remaining amount of the fuel is equal to or greater than a predetermined change amount within a unit driving section, wherein the unit driving section is a section between a current point in time at which the starting state of the engine is ON and a point in time immediately before the starting state of the engine is ON,
when it is determined that the amount of change in the remaining amount of the fuel is equal to or greater than the predetermined change amount, obtaining refueling history information within the unit driving section, the refueling history information including gas station information, a refueling amount, a refueling time period, a refueling cost, and a number of times of refueling, and
analyzing the customer refueling pattern based on the refueling history information for a predetermined period of time.

4. The apparatus of claim 3, wherein:
the refueling amount is a change in amount of the remaining amount of the fuel,
the gas station information is information on a gas station existing within a predetermined radius centered on GPS information of a vehicle at a point in time at which the remaining amount of the fuel is changed, the gas station information including at least one of a name including a brand, whether premium fuel is refueled, or whether self-refueling is possible,
the refueling time period is a date and time at which the remaining amount of the fuel is changed,
the refueling cost is a cost obtained by multiplying the refueling amount by a real-time refueling unit price of a corresponding gas station at a point in time at which the remaining amount of the fuel is changed, and
the number of times of refueling is the number of times of refueling within the unit driving section.

5. The apparatus of claim 4, wherein, when there are two or more gas stations existing within the predetermined radius, the gas station is a gas station closest to the GPS information of the vehicle at a point in time at which the remaining amount of the fuel is changed.

6. The apparatus of claim 3, further comprising a first database storing i) tag criteria set based on each of one or more of the number of times of refueling, the refueling amount, the refueling cost, the gas station information, and the refueling time period, or a combination thereof and ii) tags assigned to the tag criteria, and
wherein the at least one program comprises instructions for executing an operation of extracting a tag assigned to tag criteria satisfying the refueling history information by referring to the first database.

7. The apparatus of claim 6, further comprising a second database storing a plurality of segments composed of combinations of two or more tags, and
wherein the at least one program further comprises instructions for executing an operation of extracting, by referring the second database, a segment corresponding to a combination of two or more tags that satisfy the refueling history information.

8. The apparatus of claim 7, wherein the segment or the tag is provided in a form of Application Programming Interface (API).

9. The apparatus of claim 1, wherein analyzing the refueling pattern is performed whenever the starting state of the engine received in real time is ON.

10. The apparatus of claim 1, wherein:
the at least one program further comprises instructions for executing an operation of receiving an opening/closing state of a fuel cap in real time, and
analyzing the refueling pattern is performed each time the fuel cap is opened and closed.

11. A method for analyzing a refueling pattern, the method comprising:
receiving, by a processor, a starting state of an engine, global positioning system (GPS) information, and a remaining amount of fuel transmitted in real time; and
analyzing, by the processor, a customer refueling pattern based on the starting state of the engine, the GPS information, and the remaining amount of fuel.

12. The method of claim 11, wherein the refueling pattern comprises a customer refueling tendency including at least one of a refueling amount, gas station information, a refueling time period, a refueling cost, and a number of times of refueling, obtained based on the starting state of the engine, the GPS information, and the remaining amount of the fuel.

13. The method of claim 11, wherein analyzing the customer refueling pattern includes:
determining whether an amount of change in the remaining amount of the fuel is equal to or greater than a predetermined change amount within a unit driving section, wherein the unit driving section is a section between a current point in time when a starting state of the engine is ON and a point in time immediately before the starting state of the engine is ON,
when it is determined that the amount of change in the remaining amount of the fuel is equal to or greater than the predetermined change amount, obtaining refueling history information within the unit driving section, the refueling history information including gas station information, a refueling amount, a refueling time period, a refueling cost, and a number of times of refueling, and
analyzing the customer refueling pattern based on the refueling history information for a predetermined period of time.

14. The method of claim 13, wherein:
the refueling amount is an amount of change in the remaining amount of the fuel,
the gas station information is information on a gas station existing within a predetermined radius centered on GPS information of a vehicle at a point in time at which the remaining amount of the fuel is changed, and includes at least one of a name including a brand, whether premium fuel is refueled, and whether self-refueling is possible,
the refueling time period is a date and time at which the remaining amount of the fuel is changed,
the refueling cost is a cost obtained by multiplying the refueling amount by a real-time refueling unit price of a corresponding gas station at the time at which the remaining amount of the fuel is changed, and
the number of times of refueling is the number of times of refueling within the unit driving section.

15. The method of claim 14, wherein, when there are two or more gas stations within the predetermined radius, the gas station is a gas station closest to the GPS information of the vehicle at the time at which the remaining amount of the fuel is changed.

16. The method of claim 13, wherein analyzing the customer refueling pattern includes extracting, by referring to a first database, a tag assigned to a tag criteria satisfying the refueling history information, wherein the first database stores i) tag criteria set based on each of one or more of the number of times of refueling, refueling cost, gas station information, and refueling time period, or a combination thereof and ii) tags assigned to the tag criteria.

17. The method of claim 16, wherein analyzing the customer refueling pattern further includes extracting, by referring to a second database, a segment corresponding to a combination of two or more tags that satisfy the refueling history information, wherein the second database stores a plurality of segments composed of combinations of two or more tags.

18. The method of claim 17, wherein the segment or the tag is provided in a form of an open application programming interface (API).

19. The method of claim 11, wherein analyzing the refueling pattern is performed whenever a starting state of the engine received in real time is on.

20. A non-transitory computer-readable storage medium having computer readable instructions stored thereon, the computer readable instructions, when executed by a processor, cause the processor to:
receive a starting state of an engine, global positioning system (GPS) information, and a remaining amount of fuel transmitted in real time; and
analyze a customer refueling pattern based on the starting state of the engine, the GPS information, and the remaining amount of fuel.
